(19) United States
(12) Patent Application Publication
(10) Pub. No.: US 2007/0238796 A1
(43) Pub. Date: Oct. 11, 2007

(54) Process for the preparation of PIPA polyols

(76) Inventors: Catherine J. Lovenich, Koln (DE); Hans Hettel, Ottenhofen (DE); Bert Klesczewski, Koln (DE); Christel Fussangel, Neuss (DE)

Correspondence Address: BAYER MATERIAL SCIENCE LLC, 100 BAYER ROAD, PITTSBURGH, PA, 15205, US

(21) Appl. No.: 11/583,492

(22) Filed: Oct. 18, 2006

(30) Foreign Application Priority Data
Oct. 22, 2005 (DE) 10 2005 050 701.8

(51) Int. Cl. C08G 18/00

(52) U.S. Cl. 521/155

(57) ABSTRACT

The present invention describes a process for the preparation of PIPA polyols and their use for the production of flexible polyurethane foams.

### CROSS REFERENCE TO RELATED PATENT APPLICATION

The present patent application claims the right of priority under 35 U.S.C. §119 (a)-(d) of German Patent Application No. 10 2005 050 701, filed Oct. 22, 2005.

### BACKGROUND OF THE INVENTION

The present invention describes a process for the preparation of PIPA polyols, the PIPA polyols produced by this process, and their use in the production of flexible polyurethane foams.

PUR foams are obtained by reacting one or more polyisocyanates and one or more compounds having at least two reactive hydrogen atoms in the presence of blowing agents and other additives. A survey of the preparation of polyurethanes is given in Kunststoff-Handbuch, volume VII, “Polyurethane”, 3rd edition, 1993, by Dr G. Oertel (Carl Hanser Verlag).

Highly elastic HR (high resilience) foams are predominantly produced with filler-modified polyols. Different types of filled polyethers are known and include, for example, polymer polyols (i.e. PMPOs), polyurea dispersions (i.e. PUD polyols) and polyisocyanate polyaddition polyols (i.e. PIPA polyols). PMPOs are prepared by the free-radical copolymerization of styrene and acrylonitrile in polyols (as described in, for example, U.S. Pat. No. 3,304,273 and U.S. Pat. No. 3,823,201); PUD polyols (as described in U.S. Pat. No. 4,093,569 and GB-A 1,501,172) are prepared by the polyaddition reaction of hydrazines or amines with mono-, di- or polyisocyanates in polyols; and PIPA polyols (see “PIPA—Process for the Future”, K. Picken, Urethanes Technology, 1984, pp 23-24, and GB-A 2 072 204) are prepared by the polyaddition of polyisocyanates and alkanolamines (i.e. compounds having at least one hydroxyl group and at least one primary, secondary or tertiary amino group) in polyetherpolyols. In all three cases the polyetherpolyol is almost inert, but the reaction of a small proportion of the polyol with the filler stabilizes the dispersion.

Highly elastic foams are not only more elastic than standard foams, but also exhibit better burning properties. One aim of the flexible foam manufacturer is constant improvement of the burning properties of the foams. Different fire behavior tests are used for different end-use applications in different countries. Typical examples of these fire behavior tests are “California 117A”, “California 117D”, “Motor Vehicle Safety System 302” and “British Standard 5852 part 2, Crib V”. The last test, in particular, can generally only be passed by using a relatively high proportion of expensive flameproofing agents in the foam.

Although many PIPA polyols and their foams are known, other PIPA polyols are still being developed in order to improve specific properties of the polyols and their foams.

The stability and/or viscosity of PIPA polyols is often problematic. In EP-A 129 977, good PIPA polyols are obtained when a dispersant is used in the preparation. Without the dispersant, the products are coarse, highly viscous or solid pastes.

One aim of many developments is to increase the filler content in order to improve the properties of the foams produced with the PIPA polyol and reduce the amount of PIPA polyol to be transported. An unacceptable increase in viscosity must be avoided, however, when increasing the filler content. EP-A 79 115 describes PIPA polyols containing 40 to 80 wt. % of filler, in which part of the isocyanate component is kept back, and added at a later stage. If a polyol containing 50% of filler is prepared (as seen in Example 3), the ratio of triethanolamine to TDI is very important. For example, with 26.55 parts triethanolamine to 23.45 parts TDI, a product is obtained which can be diluted to a filler content of 10%. However, with 23.08 parts triethanolamine to 26.92 parts TDI, a viscous, lumpy product is obtained which forms aggregates when diluted to a filler content of 10%. Thus, the ratio of triethanolamine to TDI is very important in preparing PIPA polyols as described in EP-A 79 115.

In U.S. Pat. No. 4,523,025, a polyamine is reacted with alkylene oxide in the first step, and the product of this reaction is then reacted with a polyisocyanate in the presence of a polyol. If the polyamine is not reacted first with the alkylene oxide, the reaction mixture gels too rapidly, the solids settle out and/or the foams are of a poorer quality. A disadvantage of this method is that it requires an additional reaction step.

As described in WO 94/12553, in the preparation of PIPA polyols with a filler content of 25 to 70%, the viscosity is reduced and stabilized after production (i.e. with little or no viscosity increase over time) by adding a second olamine to the reaction mixture of isocyanate and olamine in a second mixing head. Without the addition of the second olamine, the product gels. In U.S. Pat. 5,179,131, the viscosity is stabilized by adding 0.05 to 0.5 part by weight of a monocarboxylic or dicarboxylic acid.

In WO 94/20558, the viscosity and stability of PIPA dispersions are improved by using a stabilizer, in which the stablizer itself is a PIPA polyol. In this way, it is possible to prepare PIPA polyols with a filler content of 30 wt. %, in which the filler does not settle out over time.

WO 00/73364 describes that the stability (and viscosity) of PIPA polyols containing 30 to 80% by weight of filler can be improved by carrying out the preparation at 60 to 100° C. and using a high shear intensity.

A process is described in DE-A 198 11 471 for the preparation of stable dispersions by the addition of a monofunctional amine (e.g. di-n-butylamine). The Comparative Examples which did not contain di-n-butylamine were either incapable of being processed as flexible foam polyol, or they resulted in a very inhomogeneous foam structure. In U.S. Pat. No. 4,293,470, a change in the viscosity of the filled polyol is avoided by adding 0.1-1.0 wt. % of a secondary amine such as dibutylamine, thereby improving the storage stability.

It is known to use water in the preparation of PIPA or PUD polyols in order to reduce the viscosity. As described in U.S. Pat. No. 4,093,569, more than 4 wt. % (and particularly preferably 10 to 25 wt. %) of water is used. The disadvantage, however, is that the large proportions of water have to be removed before foaming. Other documents described the state of the art thus teach and/or disclose the use of smaller proportions of water. In U.S. Pat. No. .4,497,913, approx. 0.1 to 0.5 wt. % of water is added in the preparation of a filled polyol from a short-chain polyol and a polyisocyanate. The WO 2004/099281 reference describes the preparation of PIPA polyols with filler contents of 1 to 80 wt. % from a short-chain polyol and an MDI-based isocyanate, in the presence of 0.1 to 5 wt. % of water.

As described in WO 00/73364, many of the processes for the preparation of PIPA polyols yield products with a high viscosity or unstable products or, in an uncontrollable reaction, produce PIPA polyols that can cause foam collapse. The PIPA polyols known and described in the state of the art tend to exhibit inhomogeneity (i.e. formation of lumps or agglomerates) or instability (i.e. phase separation or viscosity change). Therefore, the known PIPA polyols are unsuitable for the production of foams.

### SUMMARY OF THE INVENTION

The object of the present invention is to provide PIPA polyols of improved homogeneity. It has now been found that the homogeneity can be improved by adding urea in the PIPA polyol preparation.

Another object of the present invention is to provide PIPA polyols which can be used for the production of flexible polyurethane foams, in which the fire behavior of the resultant foams with respect to weight loss and burn-out time as described in accordance with “British Standard 5822 part 2, Crib V” fire behavior test is improved compared with conventional PIPA polyols.

The invention provides a process for the preparation of polyisocyanate polyaddition polyols (i.e. PIPA polyols). This process comprises (1) reacting (A) one or more polyisocyanate components, with (B) at least one amine group containing component selected from the group consisting of amines, alkanolamines and mixtures thereof, and (C) a polyetherpolyol, in the presence of (D) urea and (E) water.

### DETAILED DESCRIPTION OF THE INVENTION

A suitable polyisocyanate to be used in the process according to the present invention is preferably toluene diisocyanate (TDI), and more preferably in the form of an isomeric mixture containing 80 wt. % of 2,4-TDI (i.e. ‘TDI 80’). In another embodiment of the invention, the polyisocyanate used is diphenylmethane diisocyanate (MDI) in the form of monomeric MDI, mixtures of MDI and its higher homologues (i.e. ‘polymeric MDI’), or mixtures thereof.

Suitable amines to be used in the preparation of the PIPA polyols include, for example, mono-, di- or trifunctional amines having primary, secondary or tertiary amino groups, and preferably primary or secondary amino groups. It is possible to use aliphatic, cycloaliphatic or aromatic amines. Examples of suitable amines include compounds such as N-methyl-1,3-propanediamine, phenylhydrazine, 1,12-diamino-4,9-dioxadecane, 1,2-propylenediamine, 1,3-propylenediamine, α-aminodiphenylmethane, N,N-dibenzylethylenediamine, amino-terminated polyols (such as, e.g. Jeffamine® from Huntsman ICI), N,N-bis(3-aminopropyl)methylamine, cyclohexylamine, 3-dimethylamino-1-propylamine, diethylenetriamine and aminoethylpiperazine. Preferred amines are 1,12-diamino-4,9-dioxadecane, 1,2-propylenediamine, α-aminodiphenylmethane, N,N-dibenzylethylenediamine, difunctional polyoxypropylenamine having a number-average molecular weight of 230 g/mol (i.e. Jeffamine® D230), 3-dimethylamino-1-propylamine and diethylenetriamine.

Suitable alkanolamines for the process according to the invention include, for example, diethanolamine (DEOA), 3-amino-1-propanol, aminoethylethanolamine, aminoethanol and aminoethoxyethanol. Diethanolamine, 3-amino-1-propanol or aminoethylethanolamine is preferred. It is particularly preferable to use combinations of diethanolamine with other amines or other alkanolamines. The mixing ratio of DEOA to other amines or alkanolamines is preferably from 0.5:1 to 5:1. The NH number of the mixtures is typically from 400 to 700. The different reactivities of primary and secondary NH groups are not taken into account here. For the purposes of calculating the formulation, it is assumed that the OH groups in alkanolamines do not react.

Suitable polyetherpolyols for component (C) of the process according to the invention typically have an OH number of 28 to 56, an OH functionality of 2 to 4 and an ethylene oxide content of 15 to 20 wt. %.

An aqueous urea solution is used concomitantly in the process according to the invention. The weight ratio of urea to water is normally 1:1. The solubility of urea in water at 20° C. is 1080 g/l, so highly concentrated solutions are not possible. Overall, 0.5 to 5 parts by weight, preferably 1 to 2 parts by weight, of aqueous urea solution are used concomitantly, based on the total formulation. A more dilute solution can likewise produce homogeneous dispersions. In this case invention, the amounts have to be adapted accordingly. Very dilute solutions are of no interest, however, if their use would result in the PIPA polyols prepared therefrom containing more than approx. 3 parts of water, since 3 parts of water are typically used in foaming and an additional step (i.e. distillation to remove excess water) is undesirable.

In addition, from 0.1 to 2.0 parts by weight of an antioxidant, based on the total formulation, can optionally be added.

In the process according to the present invention, at least one polyisocyanate component, and at least one amine group containing compound selected from the group consisting of amines, alkanolamines and mixtures thereof, are used in proportions such that the ratio of isocyanate groups to isocyanate-reactive NH or NH₂ groups ranges from 0.90 to 1.1, preferably from 0.95 to 1.05 and more preferably 1:1. The PIPA polyols prepared by the process according to the invention have filler contents of from 1 to 50 wt. %, and preferably of from 10 to 20 wt. %.

The process according to the invention can be carried out by first mixing the polyetherpolyol, the amine group containing compound selected from the group b consisting of amines, alkanolamines and mixtures thereof, water and urea, and then adding the polyisocyanate. Alternatively, all the components can also be mixed simultaneously in a mixing head. The process according to the invention is normally carried out at room temperature.

The PIPA polyols prepared by the process according to the invention are distinguished by an improved homogeneity, and can thus, advantageously be processed further to produce flexible polyurethane foams.

It is assumed that urea participates chemically in the reaction in such a way as to stabilize the dispersion. As described in the WO 94/20558 reference, a PIPA polyol useful for flexible polyurethane foams must be a stable dispersion of discrete polymer particles in a base polyether. The filled polyol must also exhibit good processing properties, with the viscosity being within an acceptable range so that the filled polyol can be worked in conventional foaming units. Ideally this filled polyol should also produce a foam with a good porosity, i.e. not too much porosity, because otherwise foam collapse occurs, and not too little porosity, so as to avoid shrinkage or poor quality of the resulting foam.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all parts and percentages are parts and percentages by weight, respectively.

### EXAMPLES

The viscosities of the PIPA polyols were measured at 25° C. with a Haake “Rheostress RS75” rotational viscometer at a shear rate of 50/s. To determine the hydroxyl number (OH number), a sample of the polyol in pyridine was reacted at room temperature with excess acetic anhydride under 4-dimethylaminopyridine catalysis. The excess acetic anhydride was saponified with water and the acetic acid formed was titrated with sodium hydroxide solution. The total base content was measured by potentiometric titration: the basic constituents of a sample dissolved in acetic acid were titrated potentiometrically with perchloric acid.

The following components were used in the Examples:

| | |
|---|---|
| Polyether A: | trifunctional polyetherpolyol having an OH number |
| | 35 with an EO content of 17.5 wt. % |
| DEOA: | diethanolamine |
| Isocyanate A: | mixture of 2,4- and 2,6-TDI (80:20) having an NCO |
| | content of 48 wt. % |
| Irganox ® 1135: | an antioxidant, commercially available from Ciba |
| | Speciality Chemicals |
| Irganox ® 68b: | an antioxidant, commercially available from Ciba |
| | Speciality Chemicals |
| Amine A: | a polyoxypropylenamine having a molecular weight |
| | of 230 and an amine functionality of about 2; |
| | commercially available as Jeffamine ® D230 from |
| | Huntsman ICI |
| Tegostab ® B8681: | a foam stabilizer based on polysiloxane-polyether, |
| | commercially available from Goldschmidt AG |
| Niax ® A1: | bis(2-dimethylamino)ethyl ether in dipropylene |
| | glycol, commercially available from GE Speciality |
| | Chemicals |
| Dabco ® 33-LV: | 33% triethylenediamine, 67% dipropylene glycol, |
| | commercially available from Air Products |
| Desmorapid ® SO: | tin 2-ethylhexanoate, commercially available from |
| | Rhein Chemie |
| Levagard PP: | tris(2-chloroisopropyl)phosphate, commercially |
| | available from Rhein Chemie |

Process for Examples 1-9

Polyether A, the amines and/or alkanolamines and an aqueous urea solution (50 wt. %) were placed in a mixing beaker at room temperature. The mixture was stirred with a Pendraulik stirrer at ˜2400 rpm for two minutes. Isocyanate A was added all at once, and the mixture was stirred at ˜2400 rpm for a further 2 minutes. The mixture heated up considerably due to the exothermicity of the reaction. As soon as the dispersion had cooled to approx. 60° C., Irganox® 1135 was added.

| | | Example | | | | |
|---|---|---|---|---|---|---|
| | | 1 | 2 | 3 | 4 | 5 |
| Polyether A | parts | 77.82 | 77.81 | 77.80 | 77.80 | 77.81 |
| DEOA | parts | 10.93 | 8.12 | 8.21 | 8.12 | 8.12 |
| α-Aminodiphenylmethane | parts | | 3.49 | | | |
| N,N-dibenzylethylenediamine | parts | | | 2.90 | | |
| Amine A | parts | | | | 2.94 | |
| Aminoethylethanolamine | parts | | | | | 1.93 |
| Urea | parts | 1.0 | 1.0 | 1.0 | 1.0 | 1.0 |
| Water | parts | 1.0 | 1.0 | 1.0 | 1.0 | 1.0 |
| Irganox 1135 | parts | 0.2 | 0.2 | 0.2 | 0.2 | 0.2 |
| Isocyanate A | parts | 9.047 | 8.376 | 8.895 | 8.945 | 9.943 |

| | | | | | |
|---|---|---|---|---|---|
| Filler content (%) | 20 | 20 | 20 | 20 | 20 |
| Viscosity [at 50/s and 25° C.] (mPas) | 1850 | 4390 | 1850 | 1821 | 1908 |
| OH number (mg KOH/g) | 148 | 117 | 119 | 118 | 127 |
| Total base content (mg KOH/kg) | 1898 | 1177 | 1398 | 1197 | 3334 |

| | | Example | | | |
|---|---|---|---|---|---|
| | | 6 | 7 | 8 | 9 |
| Polyether A | parts | 77.80 | 77.80 | 77.80 | 88.90 |
| DEOA | parts | 8.12 | 8.12 | 5.36 | 4.06 |
| Aminoethylethanolamine | parts | | | | 0.97 |
| 3-Amino-1-propanol | parts | 2.39 | | | |
| 2-(2-Aminoethoxyethanol) | parts | | 2.82 | 5.58 | |
| Urea | parts | 1.0 | 1.0 | 1.0 | 0.5 |
| Water | parts | 1.0 | 1.0 | 1.0 | 0.5 |
| Irganox 1135 | parts | 0.2 | 0.2 | 0.2 | 0.1 |
| Isocyanate A | parts | 9.488 | 9.055 | 9.055 | 4.971 |

| | | | | |
|---|---|---|---|---|
| Filler content (%) | 20 | 20 | 20 | 10 |
| Viscosity [at 50/s and 25° C.] (mPas) | 2001 | 2156 | 2521 | 1217 |
| OH number (mg KOH/g) | 135 | 134 | 119 | 78 |
| Total base content (mg KOH/kg) | 2361 | 2433 | 2839 | 1077 |

All the PIPA dispersions in Examples 1-9 were homogeneous and had viscosities of between 1800 and 4500 mPa-s (at 25° C.).

In Comparative Examples 1a to 9a, the PIPA preparation was carried out without urea. The aqueous urea solution was replaced with water only. A homogeneous PIPA dispersion was obtained only in the case of Example 6a.

Process for Comparative Examples 1a-9a

Polyether A, the amines and/or alkanolamines and water were placed in a mixing beaker at room temperature. The mixture was stirred with a Pendraulik stirrer at ˜2400 rpm for two minutes. Isocyanate A was added all at once and the mixture was stirred at ˜2400 rpm for a further 2 minutes. The mixture heated up considerably due to the exothermicity of the reaction. As soon as the dispersion had cooled to approx. 60° C., Irganox® 1135 was added.

| | | Example | | | | |
|---|---|---|---|---|---|---|
| | | 1a | 2a | 3a | 4a | 5a |
| Polyether A | parts | 78.82 | 78.81 | 78.80 | 78.80 | 78.81 |
| DEOA | parts | 10.93 | 8.12 | 8.21 | 8.12 | 8.12 |
| α-Aminodiphenylmethane | parts | | 3.49 | | | |
| N,N-dibenzylethylenediamine | parts | | | 2.90 | | |
| Amine A | parts | | | | 2.94 | |
| Aminoethylethanolamine | parts | | | | | 1.93 |
| Urea | parts | — | — | — | — | — |
| Water | parts | 1.0 | 1.0 | 1.0 | 1.0 | 1.0 |
| Irganox 1135 | parts | 0.2 | 0.2 | 0.2 | 0.2 | 0.2 |
| Isocyanate A | parts | 9.047 | 8.376 | 8.895 | 8.945 | 9.943 |

| | | | | | |
|---|---|---|---|---|---|
| Filler content (%) | 20 | 20 | 20 | 20 | 20 |
| Comment | not | not | not | not | not |
| | homo- | homo- | homo- | homo- | homo- |
| | geneous | geneous | geneous | geneous | geneous: |
| | | | | | lumps |

| | | Example | | | |
|---|---|---|---|---|---|
| | | 6a | 7a | 8a | 9a |
| Polyether A | parts | 78.80 | 78.80 | 78.80 | 88.90 |
| DEOA | parts | 8.12 | 8.12 | 5.36 | 4.06 |
| Aminoethylethanolamine | parts | | | | 0.965 |
| 3-Amino-1-propanol | parts | 2.39 | | | |
| 2-(2-Aminoethoxyethanol) | parts | | 2.82 | 5.58 | |
| Urea | parts | — | — | — | — |
| Water | parts | 1.0 | 1.0 | 1.0 | 0.5 |
| Irganox 1135 | parts | 0.2 | 0.2 | 0.2 | 0.1 |
| Isocyanate A | parts | 9.488 | 9.055 | 9.055 | 4.971 |

| | | | | |
|---|---|---|---|---|
| Filler content (%) | 20 | 20 | 20 | 10 |
| Viscosity [at 50/s and 25° C.] (mPas) | 1634 | | | |
| OH number (mg KOH/g) | 134 | | | |
| Total base content (mg KOH/kg) | 1497 | | | |
| Comment | | streaks: | streaks: | not |
| | | unstable | unstable | homo- |
| | | dispersion | dispersion | geneous |

In Comparative Examples 1b to 9b the PIPA preparation was carried out without urea and without water. All the polyols in Examples 1b to 9b were inhomogeneous.

Process for Comparative Examples 1b-9b

Polyether A and the amines and/or alkanolamines were placed in a mixing beaker at room temperature. Water and/or urea were not used. The mixture was stirred with a Pendraulik stirrer at ˜2400 rpm for two minutes. Isocyanate A was added all at once and the mixture was stirred at ˜2400 rpm for a further 2 minutes. The mixture heated up considerably due to the exothermicity of the reaction. As soon as the dispersion had cooled to approx. 60° C., Irganox® 1135 was added.

| | | Example | | | | |
|---|---|---|---|---|---|---|
| | | 1b | 2b | 3b | 4b | 5b |
| Polyether A | parts | 79.82 | 79.8 | 79.80 | 79.80 | 79.81 |
| DEOA | parts | 10.93 | 8.12 | 8.21 | 8.12 | 8.12 |
| α-Aminodiphenylmethane | parts | | 3.49 | | | |
| N,N-dibenzylethylenediamine | parts | | | 2.90 | | |
| Amine A | parts | | | | 2.94 | |
| Aminoethylethanolamine | parts | | | | | 1.93 |
| Urea | parts | — | — | — | — | — |
| Water | parts | — | — | — | — | — |
| Irganox 1135 | parts | 0.2 | 0.2 | 0.2 | 0.2 | 0.2 |
| Isocyanate AT80 | parts | 9.047 | 8.376 | 8.895 | 8.945 | 9.943 |

| | | | | | |
|---|---|---|---|---|---|
| Filler content (%) | 20 | 20 | 20 | 20 | 20 |
| Comment | not | not | not | not | not homo- |
| | homo- | homo- | homo- | homo- | geneous |
| | geneous | geneous | geneous | geneous: | (coarse |
| | | | | lumps | filler |
| | | | | | particles) |

| | | Example | | | |
|---|---|---|---|---|---|
| | | 6b | 7b | 8b | 9b |
| Polyether A | parts | 79.80 | 79.80 | 79.80 | 88.90 |
| DEOA | parts | 8.12 | 8.12 | 5.36 | 4.06 |
| Aminoethylethanolamine | parts | | | | 0.965 |
| 3-Amino-1-propanol | parts | 2.39 | | | |
| 2-(2-Aminoethoxyethanol) | parts | | 2.82 | 5.58 | |
| Urea | parts | — | — | — | — |
| Water | parts | — | — | — | — |
| Irganox 1135 | parts | 0.2 | 0.2 | 0.2 | 0.1 |
| Isocyanate A | parts | 9.488 | 9.055 | 9.055 | 4.971 |

| | | | | |
|---|---|---|---|---|
| Filler content (%) | 20 | 20 | 20 | 10 |
| Comment | not | not | not | not |
| | homo- | homo- | homo- | homo- |
| | egneous | geneous | geneous | geneous |

The homogeneous PIPA dispersions prepared in Examples 1 to 9 and Example 6a were used for the production of flexible foams (Examples 10- 19):

Examples 10-19

100 parts of the PIPA polyol dispersions were stirred for 20 s with water, Tegostab® B8681, DEOA, Niax® A1 and Dabco® 33-LV. After the addition of Desmorapid® SO, the mixture was stirred for a further 10 s. Isocyanate A was then added and the mixture was stirred for 8 to 13 s (depending on start time). The reaction mixture was poured into a mold. When the rise time had ended, the foam was cured for 20 minutes at 100 to 120° C.

| | | Example | | | | |
|---|---|---|---|---|---|---|
| | | 10 | 11 | 12 | 13 | 14 |
| PIPA polyol dispersion no. | | 1 | 2 | 3 | 4 | 5 |
| PIPA polyol dispersion | parts | 100 | 100 | 100 | 100 | 100 |
| Water | parts | 3.0 | 3.0 | 3.0 | 3.0 | 3.0 |
| B8681 | parts | 0.3 | 0.3 | 0.3 | 0.3 | 0.3 |
| DEOA | parts | 1.0 | 1.0 | 1.0 | 1.0 | 1.0 |
| Niax A1 | parts | 0.05 | 0.05 | 0.05 | 0.05 | 0.05 |
| Dabco 33LV | parts | 0.15 | 0.15 | 0.15 | 0.15 | 0.15 |
| Desmorapid SO | parts | 0.25 | 0.25 | 0.25 | 0.25 | 0.18 |
| Isocyanate A | parts | 38.3 | 38.3 | 38.3 | 38.3 | 38.3 |
| Start time | s | 10 | 9 | 9 | 10 | 9 |
| Rise time | s | 95 | 90 | 100 | 115 | 95 |
| Gross density | kg/m³ | 34.4 | 36.0 | 33.0 | 31.3 | 34.6 |
| Resistance to fluid flow | mm | 70 | 100 | 75 | 90 | 80 |
| (water column) | | | | | | |
| Foam structure | | OK | OK | OK | OK | OK |

| | | Example | | | | |
|---|---|---|---|---|---|---|
| | | 15 | 16 | 17 | 18 | 19 |
| PIPA polyol dispersion no. | | 6 | 6a | 7 | 8 | 9 |
| PIPA polyol dispersion | parts | 100 | 100 | 100 | 100 | 100 |
| Water | parts | 3.0 | 3.0 | 3.0 | 3.0 | 3.0 |
| B8681 | parts | 0.3 | 0.3 | 0.3 | 0.3 | 0.3 |
| DEOA | parts | 1.0 | 1.0 | 1.0 | 1.0 | 1.0 |
| Niax A1 | parts | 0.05 | 0.05 | 0.05 | 0.05 | 0.05 |
| Dabco 33LV | parts | 0.15 | 0.15 | 0.15 | 0.15 | 0.15 |
| Desmorapid SO | parts | 0.25 | 0.25 | 0.25 | 0.25 | 0.25 |
| Isocyanate A | parts | 38.3 | 38.3 | 38.3 | 38.3 | 38.3 |
| Start time | s | 10 | 14 | 9 | 9 | 9 |
| Rise time | s | 90 | 120 | 115 | 120 | 115 |
| Gross density | kg/m³ | 33.5 | 32.9 | 35.4 | 34.0 | 31.1 |
| Resistance to fluid flow | mm | 85 | 90 | 80 | 55 | 110 |
| (water column) | | | | | | |
| Foam structure | | OK | substantial | OK | OK | OK |
| | | | shrinkage | | | |

The start time is the period of time from the beginning of the last mixing operation to an optically perceptible change or a marked increase in the volume of the reaction mixture.

The rise time is the period of time between the beginning of mixing and the maximum vertical foam expansion. The gross density is measured by determining the volume and weight of a specimen.

The resistance to fluid flow (i.e. porosity) is determined by passing air through the specimen and measuring the resistance to this air flow with the aid of a water column on a scale of 0 to 350 mm. The apparatus used for this purpose consists of a glass cylinder with millimeter scale divisions from 0 to 350 and an inside diameter of 36 mm, and an inner tube with an inside diameter of 7 mm. This inner tube terminates at the top in a T-piece which has the air feed connected to one side and the hose with the measuring head connected to the other side. The hose for the measuring head has an inside diameter of 12 mm and a length of 1.80 m. The glass cylinder is closed at the bottom and can be filled with water through a funnel attached at the back. The test apparatus is connected to a compressed air supply via two taps, a pressure reducer and a hose of arbitrary length and diameter, the pressure reducer being set to approx. 2.0 bar. The glass container is filled with distilled water until the lower edge of the meniscus reaches the H₂O standard mark. Tap 1 is then opened and the flow rate is modified at tap 2 until the lower edge of the meniscus of the inner column reaches the 0 mm mark, thereby establishing an admission pressure of 100 mm water column. After adjustment of the admission pressure, the measuring head is placed on the sample without pressure and the height of the water column appearing in the inner tube is read off. This is equal to the resistance to fluid flow of the sample.

Dispersions 1-9, prepared with the aqueous urea solution in accordance with the invention, produced acceptable flexible foams. Dispersion 6a which was prepared without urea produced an unacceptable foam which exhibited substantial shrinkage. This illustrates that the use of an aqueous urea solution in the preparation of the PIPA polyol not only results in an improvement in the homogeneity of the polyol, but can also have a positive influence on the foaming.

Comparative Examples 20-21

In Comparative Examples 20 and 21, the filled polyol was prepared with the catalyst dibutyltin dilaurate and without aqueous urea solution. Example 20 is directly comparable with Example 9. The polyols used in Examples 20 and 9 are both homogeneous, but the polyol in Example 20 causes foam collapse. The polyol in Example 21 was likewise prepared with dibutyltin dilaurate as catalyst and without aqueous urea solution. However, the resulting filled polyol was not homogeneous.

Example

| | | 20 | 21 |
|---|---|---|---|
| Polyether A | parts | 89.40 | 89.40 |
| DEOA | parts | 4.06 | 4.06 |
| Aminoethylethanolamine | parts | 0.97 | |
| 3-Amino-1-propanol | parts | | 1.20 |
| Dibutyltin dilaurate | parts | 0.03 | 0.03 |
| Isocyanate A | parts | 4.98 | 4.744 |

| | | |
|---|---|---|
| Filler content (%) | 10 | 10 |
| Viscosity [at 50/s and 25° C.] (mPas) | 1294 | not homo- |
| OH number (mg KOH/g) | 82 | geneous |
| Total base content (mg KOH/kg) | 1863 | |
| Foaming | collapse | — |

Examples 22 and 24 and Comparative Examples 23 and 25

Example 22 is a 10% PIPA prepared as in Example 9, except that in this case the PIPA polyol is prepared via a low-pressure mixing head with a mechanical stirrer. In Comparative Example 23 a standard PIPA based on TEOA and with dibutyltin dilaurate as catalyst was also prepared via a low-pressure mixing head with a mechanical stirrer. An aqueous urea solution was not used in Comparative Example 23. Both experiments yielded stable PIPA polyols, however, which were foamed on a UBT unit in Example 24 and Comparative Example 25. Although both products pass the “Crib V” fire behavior test (i.e. have a weight loss <60 g and a burn time <10 min), both the weight loss and the burn-out time for the foams produced from the PIPA polyols of the invention in Example 24, were respectively lower and shorter, than Comparative Example 25. This illustrates that the burning properties can be improved by optimizing the polyol combinations.

Example

| | | 22 | 23 |
|---|---|---|---|
| Polyether A | parts | 88.94 | 89.90 |
| DEOA | parts | 4.04 | |
| Aminoethylethanolamine | parts | 0.97 | |
| Triethanolamine | parts | | 4.7 |
| Urea | parts | 0.5 | |
| Water | parts | 0.5 | |
| Irganox 68b | parts | 0.1 | 0.1 |
| Dibutyltin dilaurate | parts | | 0.03 |
| Isocyanate A | parts | 4.94 | 5.3 |

| | | |
|---|---|---|
| Filler content (%) | 10 | 10 |

Example

| | | 24 | 25 |
|---|---|---|---|
| PIPA polyol dispersion no. | | 22 | 23 |
| PIPA polyol dispersion | parts | 100 | 100 |
| Water | parts | 2.7 | 2.7 |
| B8681 | parts | 0.35 | 0.35 |
| DEOA | parts | 1.2 | 1.2 |
| Dabco 33LV | parts | 0.2 | 0.2 |
| Levagard PP | parts | 8.0 | 8.0 |
| Desmorapid SO | parts | 0.18 | 0.22 |
| Isocyanate A | parts | 36.8 | 36.8 |
| Start time | s | 13 | 13 |
| Rise time | s | 120 | 95 |
| Gross density | kg/m³ | 39.3 | 38.2 |
| BS 5852 “Crib V” | | | |
| fire behavior test | | | |
| Weight loss (<60 g) | g | 32/29* | 34/36* |
| Burn-out time (<10 min) | min | 2.55/3.15* | 3.20/3.25* |
| Test passed | | yes | yes |

*determined in duplicate

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the preparation of polyisocyanate polyaddition polyols (PIPA polyols), comprising:
(1) reacting
(A) at least one polyisocyanate component, with
(B) at least one amine group containing component selected from the group consisting of amines and alkanolamines, and
(C) a polyetherpolyol, in the presence of
(D) urea and
(E) water.

2. The process of claim 1, wherein (A) said polyisocyanate component comprises an isomeric mixture of toluene diisocyanate which contains about 80% by weight of the 2,4-isomer.

3. The process of claim 1, wherein (B) said alkanolamine is selected from the group consisting of diethanolamine, 3-amino-1-propanol, aminoethylethanolamine and mixtures thereof.

4. The process of claim 1, wherein (B) comprises a mixture of diethanolamine with one or more amines or one or more alkanolamines.

5. PIPA polyols comprising the reaction product of
(A) at least one polyisocyanate component, with
(B) at least one amine group containing component selected from the group consisting of amines and alkanolamines, and
(C) a polyetherpolyol, in the presence of
(D) urea and
(E) water.

6. A process for the production of flexible polyurethane foams, comprising reacting at least one polyisocyanate component with at least one polyol component in which at least a portion of said polyol component comprises the PIPA polyol of claim 5.
